(19) United States
(12) Patent Application Publication
(10) Pub. No.: US 2026/0070733 A1
(43) Pub. Date: Mar. 12, 2026

(54) APPARATUS AND METHODS FOR BREWING TEA VIA PODS

(71) Applicant: Genecis Bioindustries Inc., Scarborough (CA)

(72) Inventors: Chen Peng, Suzhou (CN); Luna Yu, Scarborough (CA); Junwei LV, Toronto (CA)

(21) Appl. No.: 19/320,919

(22) Filed: Sep. 5, 2025

(30) Foreign Application Priority Data
Sep. 6, 2024 (WO) PCT/CN2024/117457

(51) Int. Cl. B65D 85/804; A23F 3/18

(52) U.S. Cl. CPC B65D 85/8049; A23F 3/18

(57) ABSTRACT

Embodiments described herein relate to apparatuses and methods for brewing tea via pods. The pods can be configured to work with existing pod-based espresso machines to build up pressure within the pod thereby enabling better brewing of teas (e.g., matcha, chai, etc.). The pods can have interlocking ribs or tabs configured to interface with the espresso machine to prevent leakage during the brewing process. The pods can be completely biodegradable (e.g., compostable). In some embodiments, the pods can include bilayer films/meshes disposed at the top and bottom of the body of the pod. In some embodiments, the bilayer films include non-woven PLA fabrics and papers with specific mesh sizes configured to allow the existing espresso machines to pierce the films and enable brewing of the teas. The tea powders (e.g., matcha powder) disposed within the pods have specific meshes to enable proper dispersion in water without agglomeration of the matcha particles in the finished beverage.

### CROSS REFERENCE

This application claims priority to and the benefit of PCT/CN2024/117457 entitled “APPARATUS AND METHODS FOR BREWING TEA VIA PODS,” filed Sep. 6, 2024, the entire contents which is hereby incorporated by reference herein.

### TECHNICAL FIELD

The embodiments described herein relate generally to tea pod apparatuses and methods of brewing tea via the same.

### BACKGROUND

Brewing matcha requires a delicate balance between water temperature and turbulence (e.g., stirring or whisking) to suspend matcha particles in the water without clumps or agglomerates in the final beverage. The brewing process is typically labor-intensive, requiring a preparer to vigorously whisk the matcha powder in a small amount of water for several minutes to manually break up the matcha clumps and create a desired foam layer on the surface of the water prior to adding additional liquid (e.g., hot water, milk, nut milk, oat milk, etc.) to finish the beverage. Furthermore, matcha powders typically need to be sifted prior to initiating the brewing process to remove the larger clumps.

### SUMMARY

Embodiments described herein relate generally to tea pod apparatuses and methods of brewing tea via the same. In particular, embodiments described herein relate to a tea pod apparatus configured to interact with existing pod-based espresso brewing machines thereby enabling brewing of tea beverages via pressurized espresso brewing processes.

In some embodiments, the tea pod apparatus includes a body configured to hold a tea material (e.g., tea leaves, matcha powder, chai tea, etc.). In some embodiments, the tea pod includes an inlet disposed at a first end of the body and an outlet disposed at a second end of the body. In some embodiments, the inlet includes a sprinkler configured to distribute water through the tea pod apparatus during the brewing process. In some embodiments, the outlet includes a connection apparatus configured to interact with existing pod-based espresso machines. In some embodiments, the tea pod includes a first film disposed at the first end of the body and a second film disposed at the second end of the body. In some embodiments, the first film and the second film are bilayer films including an inner layer and an outer layer.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of a pod apparatus, according to an embodiment.

FIG. 2 is an exploded view of a pod apparatus, according to an embodiment.

FIG. 3A is a schematic illustration of a pod apparatus from an outlet view, according to an embodiment.

FIG. 3B is a side cross-sectional view of the pod apparatus along line AA shown in FIG. 3A.

FIG. 3C is an outlet view of the pod apparatus of FIG. 3A.

FIG. 3D is a side view of the pod apparatus of FIG. 3A.

FIG. 3E is an outlet perspective view of the pod apparatus of FIG. 3A.

FIG. 3F is an inlet perspective view of the pod apparatus of FIG. 3A.

FIG. 4 is a schematic illustration of a film, according to an embodiment.

FIG. 5 is a method of brewing tea via, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to tea pod apparatuses and methods of brewing tea via the same. In particular, embodiments described herein relate to tea pod apparatuses configured to interact with existing pod-based espresso brewing machines thereby enabling brewing of tea beverages via pressurized brewing processes.

Coffee is currently commercially available in various form factors, such as in pouches of pre-ground or whole bean coffee, K-cups, pods, etc., which allows coffee to be brewed in a variety of different ways. For example, pod-based espresso brewing machines (e.g., Nespresso™) are currently available, which use a combination of pressure and hot water to extract the flavor and oils of the ground coffee disposed within the pods to produce an espresso drink ready for consumption. This enables coffee beverages to be quickly and effortlessly produced.

However, tea-based drinks have not been as successful in such automated machines and processes. This may, for example, be due to the more nuanced flavor profiles which require certain conditions for optimal flavor and health benefits to be gained. For example, the criteria for optimal tea brewing may include: a proper amount of steeping time, a certain water temperature, particular amount of water, an appropriate amount of tea leaves, herbs, spices, or other natural ingredients, appropriate ratio of tea ingredients to water, appropriate serving temperature, a size or preparation of the tea ingredients (e.g., whole or raw ingredients, diced, chopped, minced, cut, tea bag cut, granules, ground, powder diced ground), and/or an appropriate steeping mechanism (e.g., bags full of ground tea, diffuser of tea ingredients, loose tea ingredients, mesh sizes of diffuser, etc.). Moreover, there are various types of teas, such as black tea, green tea, white tea, oolong tea, herbal tea, yellow tea, pu-erh tea, and/or purple tea, each of which requires careful selection of each criterion for optimal potency of the final tea beverage.

Meanwhile, matcha, and the matcha brewing process, is unique from other teas and/or tea brewing methods. Unlike most other teas which are typically loose tea leaves or cut and placed into tea bags, matcha is a fine powder of ground green tea leaves, and it typically contains a more potent concentration of nutrients, antioxidants, and flavor. Rather than diffusing the tea flavor out of a bag and into water, matcha powder (i.e., ground or pulverized green tea, also known as, “camellia sinensis”) is suspended in the water to create a matcha beverage. The matcha brewing process requires a delicate balance between amount of water, water temperature, type of matcha, amount of matcha, particle size of matcha powder, and turbulence (e.g., stirring or whisking) to suspend the particles in water and successfully produce a final beverage without clumps or agglomerates. Matcha powders typically need to be sifted prior to initiating the brewing process to remove the larger clumps. The brewing process is usually labor-intensive, requiring a preparer to manually whisk the matcha powder in a small amount of water with vigorous side-to-side or zig-zag motions for several minutes before adding additional liquid (e.g., hot water, milk, nut milk, oat milk, etc.) to finish the beverage. Whisking prior to adding additional liquid is paramount for breaking up the matcha clumps and creating a desired foam layer on the surface of the water. Consequently, an apparatus, machine, or process for successfully suspending matcha particles in a matcha beverage without the need for manual whisking has yet to be realized.

Chai also typically involves a specialized preparation process that includes the extraction of many flavors, oils, and/or components of various spices into the final beverage. For example, chai blends usually include several ingredients with varying particle sizes, from finely ground spices to larger chunks of ginger or cinnamon. This variability can be problematic for filtration systems not designed to handle such diversity. Moreover, successfully brewing chai typically requires all spices and/or ingredients included in the chai blend to be evenly exposed to hot water to extract the full range of flavors for each spice/ingredient. Inconsistent water distribution can lead to certain spices being under-extracted, resulting in a flat or unbalanced flavor profile of the chai beverage.

Accordingly, embodiments of the apparatuses and methods described herein, which may include a tea pod apparatus including a body, a sprinkler, and bilayer films that is configured to interact with a pod-based espresso brewing machine (also referred to herein as “pod-based espresso machine” or “espresso machine”), may provide one or more benefits including, for example: 1) storage of matcha and other teas in a pod form factor; 2) improved freshness and shelf life of matcha and teas; 3) brewing of matcha and other teas via existing pod-based espresso brewing machines; 4) brewing of matcha without the need for manual whisking; 5) improved tea extraction releasing essential oils and full flavor profiles; 6) improved dispersion or suspension of matcha particles in water without clumps or agglomeration; 7) enables optimal matcha flavor and health benefits; 8) pods are fully biodegradable and/or recyclable; 9) outer layer reduces damage to piercing pin of the pod-based espresso machine; 10) adaptability to various types of teas, including black tea, green tea, matcha, white tea, oolong tea, herbal tea, yellow tea, pu-erh tea, purple tea, chai blends, spices, and other natural ingredients; 11) adaptable to various sizes and types of tea ingredients (e.g., various mesh sizes or particles sizes; 12) sprinkler enables optimal pressure, water distribution, and turbulence within the pod to adequately steep and release the full flavor and benefits of various types of teas; 13) inner layer enables tea flavors to be extracted while preventing tea grounds or spices from arriving in the final beverage; 14) inner layer provides optimal back pressure to disperse matcha particles in water as it flows through the pod; and/or 15) inner layer enables dispersion of matcha particles in water to flow out of pod and into remainder of espresso machine for dispersal into beverage container for consumption (e.g., cup, mug, etc.).

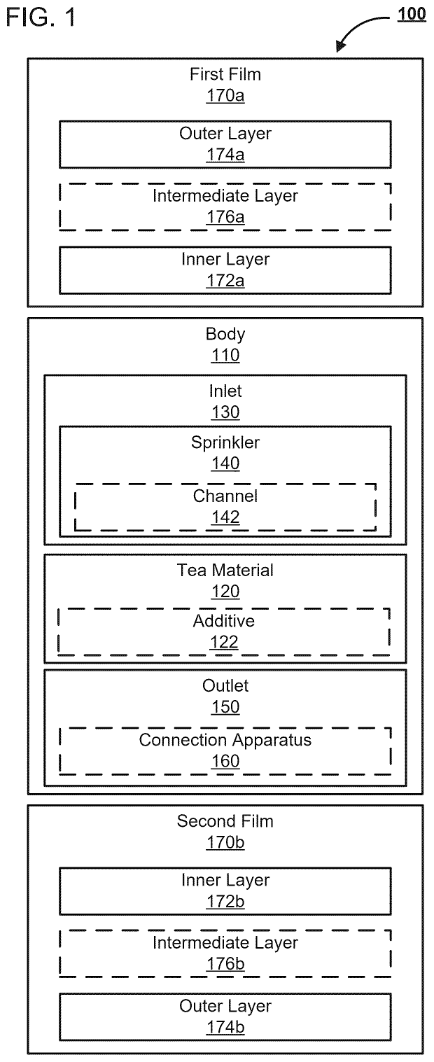

FIG. 1 is a schematic illustration of tea pod apparatus 100 (may also be referred to herein as “pod 100” or “tea pod 100”), according to an embodiment. In some embodiments, the tea pod apparatus 100 includes a body 110 defining an inner volume (not shown) configured to have a tea material 120 disposed therein. In some embodiments, the body 110 includes a first axial end (not shown) and a second axial end (not shown) opposite the first axial end (collectively referred to as “axial ends”), with the inner volume defined therebetween.

In some embodiments, the body 110 may include polymer materials, such as a biodegradable polymer material suitable for injection molding. In some embodiments, the body 110 may include biodegradable polymers such as polyhydroxyalkanoate (PHA), poly(lactic acid) (PLA), polybutylene succinate (PBS), polybutylene adipate terephthalate (PBAT), or any other suitable biopolymers or combinations thereof capable of being processed into the body 110. In some embodiments, the body 110 of the pod 100 is formed via injection molding of any of the above-mentioned biopolymers. For example, in some embodiments, the body 110 may be formed substantially of PLA via an injection molding process. While injection molding of biopolymers is mentioned above, other polymer processing techniques (e.g., extrusion, thermoforming, reactive polymer processing, blow molding, compression molding, fiber spinning, rotational molding, etc.) may be used with the above-mentioned biopolymers or other suitable materials to form the body 110 of the pod 100.

In some embodiments, the tea material 120 may include matcha powder, tea leaves, spices, chai blends, herbal tea, flavorings, natural ingredients, or any suitable combination or blend thereof. In some embodiments, the tea material 120 may be a ground powder. In some embodiments, the tea material 120 may be diced, chopped, cut, minced, whole ingredients, or any suitable combination thereof. While FIG. 1 refers to the tea material 120, the pod 100 may contain other ingredients, such as ground coffee beans, ground mushrooms (e.g., lion's mane), or any other suitable natural ingredient capable of being brewed into a beverage for consumption by humans.

In some embodiments, the tea material 120 may include an additive 122 mixed therein. In some embodiments, the additive 122 may be sugar, such as cane sugar, granulated sugar, brown sugar, powdered sugar, confectioners'sugar, muscovado sugar, demerara sugar, coconut sugar, turbinado sugar, caster sugar (may also be referred to as “superfine sugar”), any other suitable type of sugar, or any suitable combination thereof. Without being bound by theory, using sugar as the additive 122 may modify a viscosity and/or a surface tension of the water flowing through the pod 100 and/or may enable a higher amount of turbulence within the pod 100, either of which may enable better dispersion or suspension of certain tea materials 120 (e.g., matcha powder) in the water during brewing.

In some embodiments, the particle size of the tea material 120 (and/or additive 122) may be selected according to the type of material.

In some embodiments, the pod 100 includes an inlet 130 disposed at the first axial end. In some embodiments, the inlet 130 is configured to receive water (not shown) from a water source (not shown) enabling flow of the water into the pod 100. It should be understood that “water” as used herein refers to liquid phase water, gas phase water, and mixtures thereof (e.g., steam). In some embodiments, the inlet 130 may include a sprinkler 140 configured to distribute the water throughout the tea material 120. In some embodiments, the sprinkler 140 is configured to evenly distribute water into the tea material 120 enabling even brewing of the tea material 120. In some embodiments, the sprinkler 140 may be configured to enable pressure to build up within the pod 100 at a specified rate. In some embodiments, the sprinkler 140 enables turbulent flow of water within the pod 100 and/or throughout the tea material 120 disposed within the body 110. This may, for example, enable more complete brewing of the tea material 120 and/or better extraction of oils, flavors, and/or components from the tea material 120.

In some embodiments, the sprinkler 140 may include a channel 142 defined therethrough, the channel configured to enable flow of the water through the sprinkler 140 and into the inner volume. In some embodiments, the sprinkler 140 may include one channel 142, but in some embodiments, the sprinkler 140 may include a plurality of channels 142 defined therein (collectively referred to as “channels 142”). In some embodiments, the sprinkler 140 can include two channels 142, three channels 142, four channels 142, five channels 142, six channels 142, seven channels 142, eight channels 142, nine channels 142, ten channels 142, or twenty channels 142, inclusive of all values and ranges therebetween. In some embodiments, the sprinkler 140 includes about two channels 142, about three channels 142, about four channels 142, about five channels 142, about six channels 142, about seven channels 142, about eight channels 142, about nine channels 142, about ten channels 142, or about twenty channels 142, inclusive of all values and ranges therebetween. In some embodiments, the sprinkler 140 includes at least about one channel 142, at least about two channels 142, at least about three channels 142, at least about four channels 142, at least about five channels 142, at least about six channels 142, at least about seven channels 142, at least about eight channels 142, at least about nine channels 142, at least about ten channels 142, or at least about twenty channels 142, inclusive of all values and ranges therebetween. In some embodiments, the sprinkler 140 can include no more than about one channel 142, no more than about two channels 142, no more than about three channels 142, no more than about four channels 142, no more than about five channels 142, no more than about six channels 142, no more than about seven channels 142, no more than about eight channels 142, no more than about nine channels 142, no more than about ten channels 142, no more than about twenty channels 142, inclusive of all values and ranges therebetween. Combinations of the above-referenced numbers of channels 142 are also possible (e.g., at least about one channel 142 and no more than about 20 channels 142, or at least about five channels 142 and no more than about 10 channels 142), inclusive of all values and ranges therebetween.

In some embodiments, the channels 142 may be defined in a cross-sectional shape that is circular, rectangular, triangular, oval, hexagonal, polygonal, or any other suitable shape enabling flow of water through the channel. For example, each channel 142 may be defined with a circular cross-section including a diameter or other characteristic length. In some embodiments, the diameter/characteristic length may be 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm, inclusive of all values and ranges therebetween. In some embodiments, the diameter may be about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, or about 20 mm, inclusive of all values and ranges therebetween. In some embodiments, the diameter may be at least about 0.5 mm, at least about 0.6 mm, at least about 0.7 mm, at least about 0.8 mm, at least about 0.9 mm, at least about 1 mm, at least about 2 mm, at least about 3 mm, at least about 4 mm, at least about 5 mm, at least about at least 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, or at least about 20 mm, inclusive of all values and ranges therebetween. In some embodiments, the diameter may be no more than about 0.5 mm, no more than about 0.6 mm, no more than about 0.7 mm, no more than about 0.8 mm, no more than about 0.9 mm, no more than about 1 mm, no more than about 2 mm, no more than about 3 mm, no more than about 4 mm, no more than about 5 mm, no more than about 6 mm, no more than about 7 mm, no more than about 8 mm, no more than about 9 mm, no more than about 10 mm, no more than about 11 mm, no more than about 12 mm, no more than about 13 mm, no more than about 14 mm, no more than about 15 mm, no more than about 16 mm, no more than about 17 mm, no more than about 18 mm, no more than about 19 mm, or no more than about 20 mm, inclusive of all values and ranges therebetween. Combinations of the above-referenced diameters are also possible (e.g., diameter of at least about 0.5 mm and no more than about 10 mm, or at least about 0.9 mm and no more than 5 mm), inclusive of all values and ranges therebetween.

In some embodiments, each channel 142 may be defined in a rectangular cross-section including a length and a width. In some embodiments, the length may be 1 mm, 1.5 mm, 2 mm, 3 mm, 4 mm, 5 mm, 6 mm, 7 mm, 8 mm, 9 mm, or 10 mm, inclusive of all values and ranges therebetween. In some embodiments, the length may be about 1 mm, about 1.5 mm, about 2 mm, about 3 mm, about 4 mm, about 5 mm, about 6 mm, about 7 mm, about 8 mm, about 9 mm, or about 10 mm, inclusive of all values and ranges therebetween. In some embodiments, the length may be at least about 1 mm, at least about 1.5 mm, at least about 2 mm, at least about 3 mm, at least about 4 mm, at least about 5 mm, at least about 6 mm, at least about 7 mm, at least about 8 mm, at least about 9 mm, or at least about 10 mm, inclusive of all values and ranges therebetween. In some embodiments, the length may be no more than about 1 mm, no more than about 1.5 mm, no more than about 2 mm, no more than about 3 mm, no more than about 4 mm, no more than about 5 mm, no more than about 6 mm, no more than about 7 mm, no more than about 8 mm, no more than about 9 mm, or no more than about 10 mm, inclusive of all values and ranges therebetween. Combinations of the above-referenced lengths are also possible (e.g., length of at least about 1 mm and no more than about 4 mm, or at least about 1.5 mm and no more than about 2 mm), inclusive of all values and ranges therebetween. In some embodiments, the width may be 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, or 10 mm, inclusive of all values and ranges therebetween. In some embodiments, the width may be about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, or about 10 mm, inclusive of all values and ranges therebetween. In some embodiments, the width may be at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1 mm, at least about 1.5 mm, at least about 2 mm, at least about 3 mm, at least about 4 mm, at least about 5 mm, at least about 6 mm, at least about 7 mm, at least about 8 mm, at least about 9 mm, or at least about 10 mm, inclusive of all values and ranges therebetween. In some embodiments, the width may be no more than about 0.2 mm, no more than about 0.3 mm, no more than about 0.4 mm, no more than about 0.5 mm, no more than about 0.6 mm, no more than about 0.7 mm, no more than about 0.8 mm, no more than about 0.9 mm, no more than about 1 mm, no more than about 1.5 mm, no more than about 2 mm, no more than about 3 mm, no more than about 4 mm, no more than about 5 mm, no more than about 6 mm, no more than about 7 mm, no more than about 8 mm, no more than about 9 mm, or no more than about 10 mm, inclusive of all values and ranges therebetween. Combinations of the above-referenced widths are also possible (e.g., width of at least about 0.2 mm and no more than about 1.0 mm), inclusive of all values and ranges therebetween.

In some embodiments, the channels 142 may be defined in an array (or a pattern), such as a circular array, rectangular array, combinations thereof, or any other suitable array enabling flow of water through the sprinkler 140. In some embodiments, the array defines a spacing between each channel 142. In some embodiments, the spacing may be a straight-line spacing between closest points of first and second channels 142. In some embodiments, the spacing may be a radial distance between channels 142 defined along a diameter defining a circular array. In some embodiments, the channels 142 may be equidistant from the next closest channel 142. Without being bound by theory, channels 142 defined in a circular array with an equidistant spacing between each channel may enable increased amounts of turbulent flow of the water in the inner volume of the pod, enabling improved mixing of the tea material 120 within the pod 100. In some embodiments, the sprinkler 140 may include a combination of a circular array of channels 142 and a rectangular array of channels 142, such as a rectangular array defined within a diameter of the circular array.

In some embodiments, each channel 142 may include a channel inlet (not shown), a channel outlet (not shown), and a channel length (not shown) defined therebetween. In some embodiments, the channel inlet, channel outlet, and channel length may have an identical cross-sectional shape. In some embodiments, the channel inlet, channel outlet, and/or channel length may vary in cross-sectional shape. For example, in some embodiments where the channel 142 is defined in a rectangular shape, the channel inlet has a first length and a first width while the channel outlet may have a second length and a second width that is different from the first length and/or first width. For example, the channel 142 may be defined in a tapered shape along the channel length thereof (e.g., a greater diameter or width at the channel inlet versus the channel outlet, or vice versa).

In some embodiments, the pod 100 includes an outlet 150 configured to flow the brewed tea material 142 out of the pod 100 and into the remainder of the pod-based espresso machine to dispense the brewed tea material 142 into a container (not shown). In some embodiments, the outlet 150 includes a connection apparatus 160 configured to interact with an internal chamber (e.g., a pod holder) of an existing pod-based espresso machine. The existing pod-based espresso machines typically include internal chambers having walls with ridges configured to hold pods in place. Without being bound by theory, the connection apparatus 160 may, for example, enable the pod 100 to interact with the ridges of the internal chamber of the espresso machine to form a seal therebetween to prevent leaks without the need for a separate O-ring. In some embodiments, the connection apparatus 160 includes a ridge (not shown) and/or a channel (not shown) configured to interact with a corresponding slot (not shown), channel (not shown), or corresponding ridge (not shown) defined in the internal chamber (or “pod holder”) of the espresso machine. In some embodiments, the connection apparatus 160 includes a plurality of ridges and/or a plurality of channels configured to interact with a plurality of channels and/or ridges defined in the internal chamber (or pod holder) of the espresso machine. In some embodiments, the ridges, and/or connection apparatus 160, may be defined at an outer edge of the outlet 150 of the pod 100. In some embodiments, the connection apparatus 160, the ridge, and/or the plurality of ridges are configured to matingly couple to one or more corresponding slots, channels, and/or ridges disposed in the internal chamber and/or the pod holder of the espresso machine.

In some embodiments, each ridge may be rectangular in shape including a length and a width configured to fit withing a corresponding length or a corresponding width of the corresponding channel defined in the pod holder of the espresso machine.

In some embodiments, the pod 100 includes a first film 170a and a second film 170b (collectively referred to as “films 170”) disposed at opposite axial ends of the body 110. In some embodiments, the films 170 are configured to create a seal at each corresponding axial end of the body 110 thereby encapsulating the tea material 120 therebetween.

In some embodiments, the first film 170a is configured to receive water thereby enabling water to enter the inlet 130 and/or the body 110 of the pod 100. In some embodiments, the first film 170a is configured to receive water from a water source operably coupled to the pod-based espresso machine. For example, the espresso machine may include needles (not shown) having water pipelines (not shown) operably connected to a water source (not shown) configured to flow water through the espresso machine and into the pod 100. The needles having water pipelines may enable transport of water into the pod 100 by puncturing the first film 170a. The first film 170a may be configured to be punctured by the needles having water pipelines operably connected to the water source thereby enabling water to enter the inlet 130 and/or flow through the sprinkler 140 to be distributed in the tea material 120 for brewing.

In some embodiments, the second film 170b is configured to build pressure within the pod 100. For example, in some embodiments, the second film 170b is configured to build pressure within the body 110 of the pod 100 by producing a backpressure during and/or after flow of the water within the pod 100. For example, in some embodiments, the water flows into the pod 100 through the first film 170a, the inlet 130, and/or the sprinkler 140 and is distributed into the tea material 120 disposed within the body 110, and the second film 170b enables a backpressure against the flow of water to build pressure within the pod 100. In some embodiments, the second film 170b may be configured to release the tea material 120 during and/or after brewing (may also be referred to as “brewed tea material 120”) from the body 110 to the remainder of the espresso machine (e.g., a nozzle) for dispensing into a beverage container and/or into directly into the beverage container. In some embodiments, the second film 170b is configured to be punctured by a piercing needle (not shown) operably coupled to the pod-based espresso machine to release the brewed tea material 120 during and/or after brewing of the tea material 120. In some embodiments, the second film 170b may be configured to rupture upon an overpressure within the pod 100 enabling release of the tea material 120 from the body 110. In some embodiments, the second film 170b may be configured to rupture during and/or after being punctured by the piercing needle, thereby enabling disposal of the brewed tea material 120 into the remainder of the espresso machine and/or the beverage container. In some embodiments, the second film 170b may act as a filter releasing small particles below a certain particle size threshold but preventing large particle sizes above the particle size threshold from escaping from the pod 100. In some embodiments, the second film 170b may enable multiple brewing stages, for example, by enabling pressure to build within the pod 100, enabling brewing of the tea material 120 via the pressure build up and/or turbulent flow of water flowing within the pod 100, enabling release of a portion of the tea material 120 (e.g., having small particle sizes and/or having been dispersed in the water within the pod 100) from the pod 100, and/or enabling release of the a portion of the tea material 120 after rupturing due to puncture and/or overpressure.

In some embodiments, one or both of films 170 may be a “bilayer film”. For example, the first film 170a may include an inner layer 172a and an outer layer 174a disposed on the inner layer 172a and axially external to the inner layer 172a. Likewise, the second film 170b may include an inner layer 172b and an outer layer 174b disposed on the inner layer 172b and axially external to the inner layer 172b. Films 170 may also include three or more layers.

In some embodiments, the inner layer 172a of the first film 170a and the inner layer 172b of the second layer 170b (collectively referred to as “inner layers 172”) may be formed of a polymer material. In some embodiments, the inner layers 172 may be configured to adhere the film 170 to the body 110 of the pod 100.

In some embodiments, the inner layers 172 may include biodegradable polymers such as polyhydroxyalkanoate (PHA), poly(lactic acid) (PLA), polybutylene succinate (PBS), polybutylene adipate terephthalate (PBAT), any other suitable biopolymers that can be processed into non-woven fabrics, and any suitable combination thereof. In some embodiments, each inner layer 172 includes a non-woven fabric formed of any of the above-mentioned biopolymers. For example, in some embodiments, each inner layer 172 may include a PLA non-woven fabric. In some embodiments, the inner layers 172 may each be a mesh, such as a PLA mesh.

In some embodiments, the inner layers 172 may be configured to act as a mesh or filter to prevent larger tea particles from escaping during brewing while allowing smaller particles to flow into the finished beverage.

In some embodiments, the outer layer 174a of the first film 170a and the outer layer 174b of the second film 170b (collectively referred to as “outer layers 174”) may be formed of a biodegradable material. In some embodiments, the outer layers 174 may be configured to provide moisture-barrier or oxygen-barrier properties to at least partially prevent moisture and/or oxygen from entering the pod 100 prior to use. In some embodiments, the outer layers 174 may also be configured to facilitate easy piercing of the films 170 by a piercing component (not shown) and/or a water injection component (not shown) of the espresso machine (e.g., a piercing pin) without degradation of the piercing component or the water injection component.

In some embodiments, the outer layers 174 may include a cellulosic material, such as a paper. In some embodiments, the outer layers 174 may be filter paper. In some embodiments, the outer layers 174 may include a thin barrier layer providing moisture-barrier and/or oxygen-barrier properties to the pod 100. This may, for example, enable a longer shelf life for the tea material 120 disposed within the pod 100.

In some embodiments, the first film 170a may include an intermediate layer 176a and the second film 170b may include an intermediate layer 176b (collectively referred to as “intermediate layers 176”). In some embodiments, each of the intermediate layers 176 may be interposed between the corresponding inner layer 172 and the corresponding outer layer 174. In some embodiments, the intermediate layers 176 may be configured to adhere the inner layer 172 to the outer layer 174, or vice versa. The intermediate layers 176 may include naturally occurring adhesive materials, such as resins or rosins, or synthetic adhesive materials.

In some embodiments, the pod 100 may be configured to receive hot water from the espresso machine to enable brewing of the tea material 120 at high temperatures and pressures. Without being bound by theory, pressurizing the tea material 120 within the body 110 of the pod 100 with hot water from the espresso machine may create a turbulent flow within the pod 100 and enable better extraction and/or dispersion of the tea material 120 to form a more potent finished beverage. For example, in embodiments where the tea material 120 is matcha, pressurized brewing of the matcha may allow for superior dispersion of matcha particles in the finished beverage. In some embodiments, during operation within the espresso machine, the pod 100 may be configured to have an internal pressure of 3 bars, 4 bars, 5 bars, 6 bars, 7 bars, 8 bars, 9 bars, 10 bars, 11 bars, 12 bars, 13 bars, 14 bars, 15 bars, 16 bars, 17 bars, 18 bars, 19 bars, 20 bars, 21 bars, 22 bars, 23 bars, 24 bars, or 25 bars, inclusive of all values and ranges therebetween. In some embodiments, the internal pressure within the pod 100 during operation may be about 3 bars, about 4 bars, about 5 bars, about 6 bars, about 7 bars, about 8 bars, about 9 bars, about 10 bars, about 11 bars, about 12 bars, about 13 bars, about 14 bars, about 15 bars, about 16 bars, about 17 bars, about 18 bars, about 19 bars, about 20 bars, about 21 bars, about 22 bars, about 23 bars, about 24 bars, or about 25 bars, inclusive of all values and ranges therebetween. In some embodiments, the internal pressure within the pod 100 during operation may be at least about 3 bars, at least about 4 bars, at least about 5 bars, at least about 6 bars, at least about 7 bars, at least about 8 bars, at least about 9 bars, at least about 10 bars, at least about 11 bars, at least about 12 bars, at least about 13 bars, at least about 14 bars, at least about 15 bars, at least about 16 bars, at least about 17 bars, at least about 18 bars, at least about 19 bars, at least about 20 bars, at least about 21 bars, at least about 22 bars, at least about 23 bars, at least about 24 bars, or at least about 25 bars, inclusive of all values and ranges therebetween. In some embodiments, the internal pressure within the pod 100 during operation may be no more than about 3 bars, no more than about 4 bars, no more than about 5 bars, no more than about 6 bars, no more than about 7 bars, no more than about 8 bars, no more than about 9 bars, no more than about 10 bars, no more than about 11 bars, no more than about 12 bars, no more than about 13 bars, no more than about 14 bars, no more than about 15 bars, no more than about 16 bars, no more than about 17 bars, no more than about 18 bars, no more than about 19 bars, no more than about 20 bars, no more than about 21 bars, no more than about 22 bars, no more than about 23 bars, no more than about 24 bars, or no more than about 25 bars, inclusive of all values and ranges therebetween. Combinations of the above-referenced internal pressures of the pod 100 during operation are also possible (e.g., at least about 10 bars and no more than about 25 bars, or at least about 12 bars and no more than about 20 bars), inclusive of all values and ranges therebetween.

In some embodiments, the pod 100 may be configured to receive hot water from the espresso machine to enable brewing of the tea material 120 at high temperatures. In some embodiments, the hot water may be injected into the pod 100 at a water temperature of 75° C., 76° C., 77° C., 78° C., 79° C., 80° C., 81° C., 82° C., 83° C., 84° C., 85° C., 86° C., 87° C., 88° C., 89°C., 90° C., 91° C., 92° C., 93° C., 94° C., 95° C., 96° C., 97° C., 98° C., 99° C., or 100° C., inclusive of all values and ranges therebetween. In other words, the pod 100 may be configured to operate at a brewing temperature of 75° C., 76° C., 77° C., 78° C., 79° C., 80° C., 81° C., 82° C., 83°C., 84° C., 85° C., 86° C., 87° C., 88° C., 89° C., 90° C., 91° C., 92° C., 93° C., 94° C., 95° C., 96° C., 97° C., 98° C., 99° C., or 100° C., inclusive of all values and ranges therebetween. In some embodiments, the brewing temperature may be about 75° C., about 76° C., about 77° C., about 78° C., about 79° C., about 80° C., about 81° C., about 82° C., about 83° C., about 84° C., about 85°C., about 86° C., about 87° C., about 88° C., about 89° C., about 90° C., about 91° C., about 92°C., about 93° C., about 94° C., about 95° C., about 96° C., about 97° C., about 98° C., about 99°C., or about 100° C., inclusive of all values and ranges therebetween. In some embodiments, the brewing temperature may be at least about 75° C., at least about 76° C., at least about 77° C., at least about 78° C., at least about 79° C., at least about 80° C., at least about 81° C., at least about 82° C., at least about 83° C., at least about 84° C., at least about 85° C., at least about 86°C., at least about 87° C., at least about 88° C., at least about 89° C., at least about 90° C., at least about 91° C., at least about 92° C., at least about 93° C., at least about 94° C., at least about 95°C., at least about 96° C., at least about 97° C., at least about 98° C., at least about 99° C., or at least about 100° C., inclusive of all values and ranges therebetween. In some embodiments, the brewing temperature may be no more than about 75° C., no more than about 76° C., no more than about 77° C., no more than about 78° C., no more than about 79° C., no more than about 80°C., no more than about 81° C., no more than about 82° C., no more than about 83° C., no more than about 84° C., no more than about 85° C., no more than about 86° C., no more than about 87°C., no more than about 88° C., no more than about 89° C., no more than about 90° C., no more than about 91° C., no more than about 92° C., no more than about 93° C., no more than about 94°C., no more than about 95° C., no more than about 96° C., no more than about 97° C., no more than about 98° C., no more than about 99° C., or no more than about 100° C., inclusive of all values and ranges therebetween. Combinations of the above-referenced brewing temperatures are also possible (e.g., at least about 80° C. and no more than about 99° C., or at least about 85°C. and no more than about 98° C.), inclusive of all values and ranges therebetween.

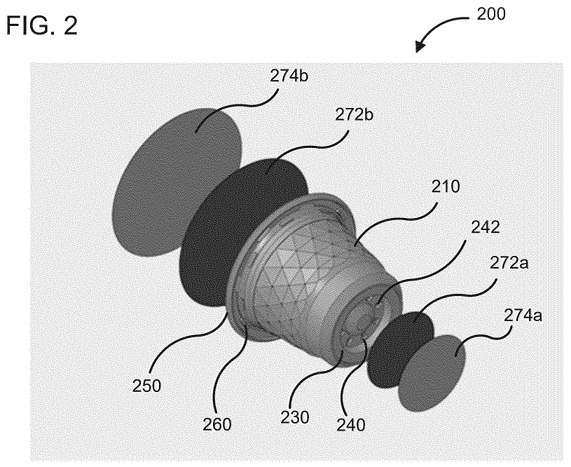

FIG. 2 is an exploded view of tea pod apparatus 200 (may also be referred to as “pod 200”, “tea pod 200”, or “pod apparatus 200”), according to an embodiment. The tea pod 200 may include a body 210 and a tea material (not shown) disposed therein. In some embodiments, tea pod 200 may include an inlet 230 defined in the body 210 at a first axial end thereof. In some embodiments, the inlet 230 is configured to receive water from an espresso machine (not shown). In some embodiments, the inlet 230 includes a sprinkler 240 including a plurality of channels 242 defined therethrough to enable flow of water into the tea material. As shown, the plurality of channels 242 are defined in a circular array. In some embodiments, the tea pod 200 may include an outlet 250 defined in the body 210 at a second axial end thereof, the second axial end opposite the first axial end (collectively referred to as axial ends). In some embodiments, the outlet 250 may be configured to allow brewed tea material to exit the tea pod 200 and enter a remainder of the espresso machine to be dispensed into a container for consumption. In some embodiments, the outlet 250 includes a connection apparatus 260 including a plurality of ribs defined around an edge thereof. In some embodiments, the ribs may be configured to connect with a pod holder of the espresso machine. In some embodiments, the tea pod 200 may include a first inner layer 272a disposed proximate the inlet 230 of the body 210, and a second inner layer 272b disposed proximate the outlet 250 of the body. In some embodiments, the first inner layer 272a and the second inner layer 272b (collectively referred to as “inner layers 272”) each has a corresponding outer layer 274a and 274b disposed thereon (collectively referred to as “outer layers 274”). In some embodiments, the tea pod 200 (and each of the components thereof) may be substantially the same as the tea pod 100 (and each of the components thereof) as described with respect to FIG. 1, and, therefore, the pod 200 is not described in further detail herein.

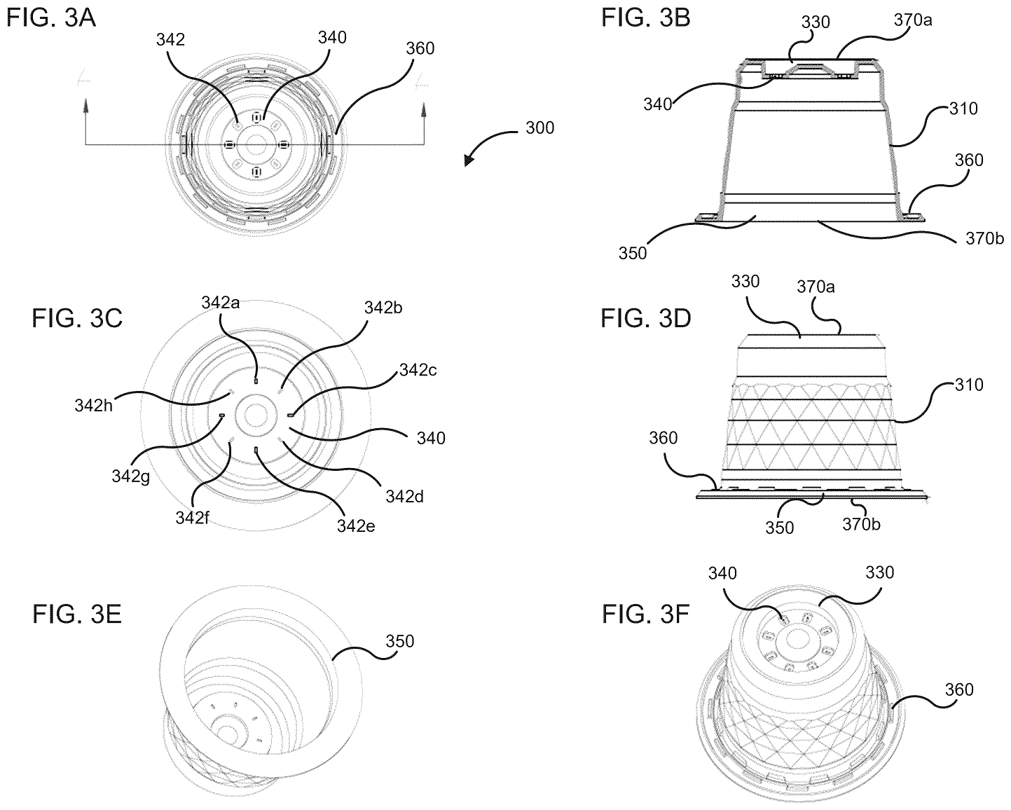

FIG. 3A-3F display various views of the tea pod apparatus 300, which may be substantially the same as the tea pod apparatus 200 as previously described with respect to FIG. 2, according to an embodiment. FIG. 3A is an internal schematic illustration of the tea pod 300, displaying the sprinkler 340, the channels 342, the connection apparatus 360, and a section line AA, according to an embodiment. FIG. 3B is an internal cross-sectional view of a tea pod apparatus 300 along the section line AA, displaying the body 310, the inlet 330, the sprinkler 340, the outlet 350, the connection apparatus 360, the first film 370a, and the second film 370b, according to an embodiment. FIG. 3C is an internal schematic illustration of the inlet 340 of a tea pod apparatus 300 displaying eight channels 342a, 342b, 342c, 342d, 342e, 342f, 342g, and 342h (collectively referred to as channels 342) having a rectangular cross-sectional shape and distributed evenly in a circular array, according to an embodiment. FIG. 3D is an external side view of the tea pod apparatus 300 displaying the body 310, the inlet 330, the outlet 350, the connection apparatus 360, the first film 370a, and the second film 370b with an ornamental design on an external surface of the pod 300, according to an embodiment. FIG. 3E is an external perspective view of the tea pod apparatus 300 displaying the outlet 350, according to an embodiment. FIG. 3F is an external perspective view of the tea pod apparatus 300 displaying the inlet 330, the sprinkler 340, and the connection apparatus 360, according to an embodiment. In some embodiments, the connection apparatus 360 includes a ridge, and/or a plurality of ridges, configured to matingly couple to one or more corresponding slots, channels, and/or ridges defined in an internal chamber and/or a pod holder of a pod-based espresso machine. In some embodiments, and as previously mentioned, the pod 300, and all components thereof, may be substantially the same as the pod 100 as described with respect to FIG. 1 and/or the pod 200 as described with respect to FIG. 2, and, therefore, is not described in further detail herein.

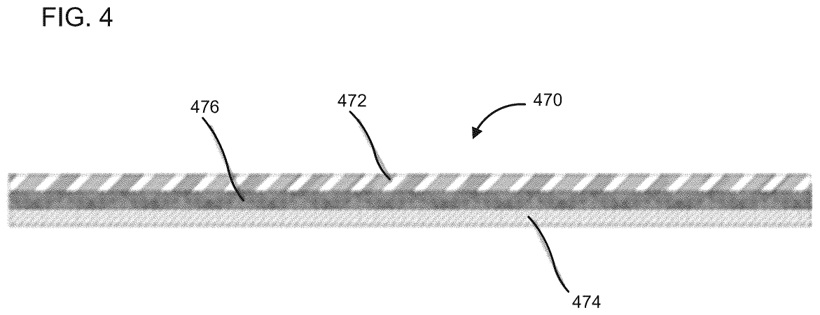

FIG. 4 displays a bilayer film 470 including an inner layer 472, an outer layer 474, and an optional intermediate layer 476, according to an embodiment. In some embodiments, the bilayer film 470 and all components thereof may be substantially the same as the films 170 as previously described with respect to FIG. 1, and/or the films 270 as previously described with respect to FIG. 2, and, therefore, is not described in further detail herein.

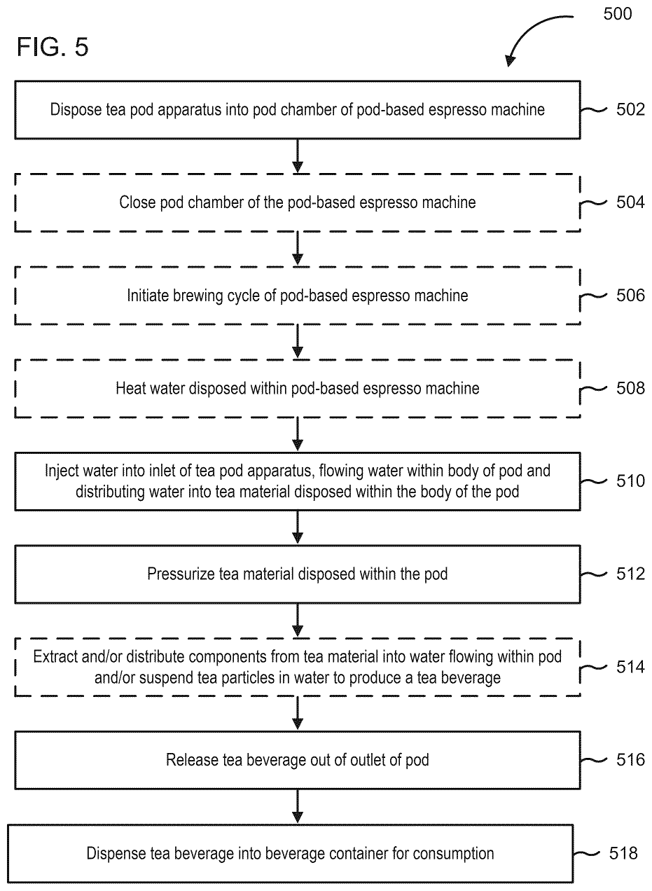

FIG. 5 describes a process 500 of brewing tea via the tea pod apparatus 100, according to an embodiment. Although the process 500 is described with respect to the tea pod apparatus 100 as described in FIG. 1, the process 500 may be carried out with any of the tea pod apparatuses described herein (e.g., 200, 300) or any other pods suitable for brewing tea. At operation 502, dispose the tea pod apparatus 100 into a pod chamber of a pod-based espresso machine. At operation 504, close the pod chamber of the pod-based espresso machine. At 506, initiate a brewing cycle on the pod-based espresso machine. At 508, heat water disposed in the pod-based espresso machine.

At operation 510, inject water into the body 110 of the tea pod apparatus 100 through the inlet 130, flowing the water within the body 110 of the pod 100 and distributing the hot water into the tea material 120 disposed within the body 110. In some embodiments, the water is injected through the first film 170a and into the inlet 130 of the pod 100. In some embodiments, the water flows from the water source (not shown) through the pod-based espresso machine and into the inlet 130 of the pod 100. In some embodiments, the pod-based espresso machine is configured to pierce the first film 170a thereby enabling flow of water into the tea material 120 disposed in the body 110 of the pod 100. In some embodiments, the water flows from the inlet 130 and through the sprinkler 140 to distribute water into the tea material 120. In some embodiments, the water is injected into the pod 100 at an initial pressure generated by the pod-based espresso machine. In some embodiments, the initial pressure may be between about 3 bars, about 4 bars, 5 bars, about 6 bars, about 7 bars, about 8 bars, about 9 bars, about 10 bars, about 11 bars, about 12 bars, about 13 bars, about 14 bars, about 15 bars, about 16 bars, about 17 bars, about 18 bars, about 19 bars, about 20 bars, about 21 bars, about 22 bars, about 23 bars, about 24 bars, or about 25 bars, inclusive of all values and ranges therebetween. In some embodiments, the first film 170a, the inlet 130, and/or the sprinkler 140 are configured to enable the water to flow into the pod 100 with an initial pressure drop. In some embodiments, the initial pressure drop is between about 0.1 bar to about 1.5 bars, inclusive of all values and ranges therebetween (e.g., about 0.5 bar to about 1.0 bar). In some embodiments, the water saturates the tea material 120.

At operation 512, pressurize tea material 120 disposed within the pod 100. In some embodiments, operation 512 may include several operations. For example, in some embodiments, the water flows at the initial pressure produced by the espresso machine and is injected into the body 110 of the pod 100 to generate an internal pressure within the pod 100. In some embodiments, the water enters the pod 100 through the first film 170a, the inlet 130, and/or the sprinkler 140 configured to flow the water into the body 110 with the initial pressure drop. In some embodiments, the water contacts the second film 170b enabling a buildup of pressure within the pod 100 to generate the internal pressure. In some embodiments the second film 170b facilitates buildup of pressure within the pod 100. For example, in some embodiments, the second film 170b facilitates buildup of pressure within the body 110 of the pod 100 by producing a backpressure during and/or after the injection of water within the pod 100 (of operation 510). For example, in some embodiments, water flows into the pod 100 through the first film 170a, the inlet 130, and/or the sprinkler 140 and is distributed into the tea material 120 disposed within the body 110, and the second film 170b generates the internal pressure by producing backpressure against the flow of water. In some embodiments, the sprinkler 140 enables an even buildup of pressure within the pod 100, for example, by facilitating buildup of pressure within the pod 100 without localized high-pressure areas. In some embodiments, after an initial buildup of pressure within the pod 100, the pressure stabilizes at an internal stabilization pressure. In some embodiments, the internal stabilization pressure may be between about 3 bars, about 4 bars, 5 bars, about 6 bars, about 7 bars, about 8 bars, about 9 bars, about 10 bars, about 11 bars, about 12 bars, about 13 bars, about 14 bars, about 15 bars, about 16 bars, about 17 bars, about 18 bars, about 19 bars, about 20 bars, about 21 bars, about 22 bars, about 23 bars, about 24 bars, or about 25 bars, inclusive of all values and ranges therebetween. In some embodiments, the pressure within the pod reaches a maximum pressure after the initial pressure drop, the buildup of pressure to the internal pressure, and/or reaching the internal stabilization pressure. In some embodiments, the maximum pressure is about equivalent to the initial pressure generated by the espresso machine.

At operation 514, extract and/or distribute components from the tea material 120 into water flowing within the pod 100 and/or disperse tea particles in water flowing within pod 100 to produce a tea beverage. The components of the tea material 120 may be, for example, oils, tea particles, tannins, etc. In some embodiments, operation 514 occurs completely or partially simultaneously with operation 512. For example, in some embodiments, operation 514 occurs during and/or after reaching the internal pressure within the pod. In some embodiments, operation 514 occurs before, during, and/or after reaching the internal stabilization pressure.

At operation 516, release the tea beverage out of the outlet 150 of the pod 100. In some embodiments, the second film 170b may release the tea material 120 during and/or after brewing (i.e., the “brewed tea material 120”) from the body 110 to the remainder of the espresso machine (e.g., a nozzle) for dispensing into a beverage container and/or into directly into the beverage container. In some embodiments, the second film 170b is punctured by a piercing needle (not shown) operably coupled to the pod-based espresso machine to release the brewed tea material 120 during and/or after brewing of the tea material 120. In some embodiments, the second film 170b is configured to rupture after the pressure within the pod 100 reaches the maximum pressure. In some embodiments, the second film 170b may rupture upon an overpressure within the pod 100 to release of the tea material 120 from the body 110. In some embodiments, the second film 170b may rupture during and/or after being punctured by the piercing needle, thereby enabling disposal of the brewed tea material 120 into the remainder of the espresso machine and/or the beverage container. In some embodiments, the second film 170b may act as a filter releasing small particles below a certain particle size threshold but preventing large particle sizes above the particle size threshold from escaping from the pod 100. In some embodiments, the second film 170b may enable multiple brewing/release stages, for example, by enabling pressure to build within the pod 100 (e.g., operation 512), enabling brewing of the tea material 120 via the pressure build up and/or turbulent flow of water flowing within the pod 100 (e.g., operation 514), enabling release of a portion of the tea material 120 (e.g., having small particle sizes and/or having been dispersed in the water within the pod 100) from the pod 100, and/or enabling release of the a portion of the tea material 120 after rupturing due to puncture and/or overpressure. At operation 518, dispense the tea beverage into a beverage container for consumption.

As used herein, the terms “about” and “approximately” generally mean plus or minus 10% of the stated value. For example, about 0.5 would include 0.45 and 0.55, about 10 would include 9 to 11, about 1000 would include 900 to 1100.

As utilized herein, the terms “substantially” and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The terms “coupled,” and the like as used herein mean the joining of two members directly or indirectly to one another. Such joining may be stationary (e.g., permanent) or moveable (e.g., removable, or releasable). Such joining may be achieved with the two members, or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A pod apparatus for brewing tea, comprising:
a body having an inlet and an outlet, the outlet opposite the inlet;
a sprinkler disposed at the inlet, the sprinkler configured to enable hot water to flow into the body to brew a tea material disposed therein;
a first film disposed at the inlet; and
a second film disposed at the outlet, the second film configured to release the brewed tea material from the body.
